(19) United States
(12) Patent Application Publication
(10) Pub. No.: US 2009/0027726 A1
(43) Pub. Date: Jan. 29, 2009

(54) IMAGE PROCESSING APPARATUS, IMAGE PROCESSING METHOD, AND STORAGE MEDIUM

(76) Inventor: Takeshi KAJIKAWA, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/178,730

(22) Filed: Jul. 24, 2008

(30) Foreign Application Priority Data
Jul. 27, 2007 (JP) 2007-196294

(51) Int. Cl. G06K 15/00

(52) U.S. Cl. 358/1.16

(57) ABSTRACT

A image processing apparatus including a log setting module that sets a log recording setting corresponding to each of a plurality of processes executed at the image processing apparatus. The image processing apparatus also includes a memory for storing the log recording setting, and a module that determines, based on the log recording setting, whether log information should be recorded.

### CROSS REFERENCE TO RELATED APPLICATIONS

This application is based upon and claims priority under 35 U.S.C. §119 from Japanese Patent Application No. 2007-196294, filed Jul. 27, 2007, the entire contents of which is hereby incorporated by reference.

### BACKGROUND OF THE INVENTION

1. Field of the Invention

The present invention generally relates to an image processing apparatus, an image processing method, and a storage medium, and more particularly, to an image processing apparatus and an image processing method that controls selecting log information to be recorded.

2. Description of the Related Art

In the related art, an apparatus management system recording job logs of processing performed at a MFP (Multi Function Printer) or a printer is used for purposes of information security and TCO (Total Cost Ownership) reduction.

For example, an image processing apparatus records user operations for calculating a correct paper reduction effect in the re-print of a stored document. The image processing apparatus is able to set a recording condition “valid” or “invalid,” wherein all the user operations are recorded to the log when the recording condition is “valid.”

On the other hand, a security management system manages recording of log information according to a document security policy, which determines a security level of the document, wherein the log information is forced to be recorded when the security level is applied to the document. In this configuration, the security management system does not refers to a job log.

### SUMMARY OF THE INVENTION

Embodiments of the present invention provide an image processing apparatus, a image processing method, and a storage medium containing program code for causing a computer to perform the image processing method that solves or reduces one or more problems caused by the limitations and disadvantages of the related art, and controls selecting execution log information of a processing to be recorded based on a security setting of the processing. The present invention improves efficiency of recording execution log information of the image processing apparatus, which has a various processing execution log information to be recorded.

### BRIEF DESCRIPTION OF THE DRAWINGS

FIG. 1 is a diagram showing a hardware configuration of an exemplary image processing apparatus according to an embodiment of the present invention;

FIG. 2 is a diagram showing a software configuration of an exemplary image processing apparatus according to an embodiment of the present invention;

FIG. 3 is a diagram showing a function block configuration of an exemplary log recording system of an image processing apparatus according to an embodiment of the present invention;

FIG. 4 is a diagram showing a detailed function block configuration of an exemplary log management module of an image processing apparatus according to an embodiment of the present invention;

FIG. 5 is a diagram showing a data structure of an exemplary log type recording setting;

FIG. 6 is a diagram showing a data structure of exemplary log type support information;

FIG. 7 is a diagram showing a data structure of an exemplary log level recording setting;

FIG. 8 is a diagram showing a data structure of an exemplary log type-log level recording setting

FIG. 9 is a flow chart showing an exemplary image processing apparatus according to an embodiment of the present invention;

FIG. 10 is a diagram showing a data structure of exemplary log information;

FIG. 11 is a diagram showing a user interface of an exemplary log recording setting;

### DESCRIPTION OF THE PREFERRED EMBODIMENTS

Embodiments of the present invention are described below with reference to the accompanying drawings, but the present invention is not limited to the embodiments described below.

In the embodiments of the present invention described herein, the image processing device is exemplary explained as a MFP, which executes image processing such as copy, fax, scan, and/or print.

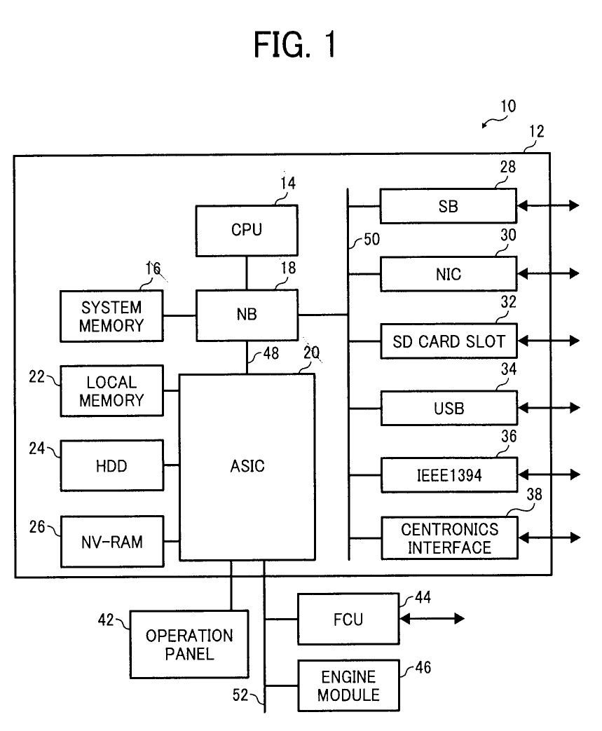

FIG. 1 is a diagram showing a hardware configuration of an exemplary image processing apparatus according to an embodiment of the present invention.

Referring to FIG. 1, a MFP 10 includes controller 12, operation panel 42, FCU (facsimile control unit) 44, and engine module 46. The controller 12 includes CPU (central processing unit) 14, system memory 16, NB (north bridge) 18, ASIC 20, local memory 22, HDD (Hard Disk Drive) 24, NV-RAM 26, SB (south bridge) 28, SD card slot 32, USB interface 34, IEEE1394 interface 36, CENTRONICS interface 38, AGP (Accelerated Graphics Port) 48, and PCI bus 50.

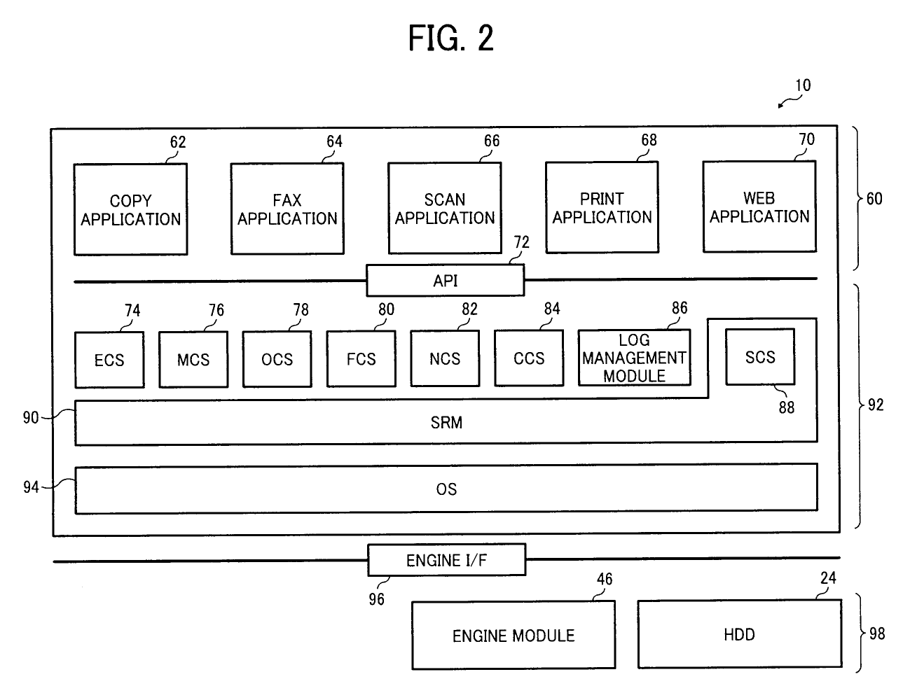

FIG. 2 is a diagram showing a software configuration of an exemplary image processing apparatus according to an embodiment of the present invention.

Referring to FIG. 2, the MFP 10 includes an application layer 60, an API (Application Programming Interface) 72, a platform layer 92, an engine interface (I/F) 96, and a hardware resource 98.

The application layer 60 provides a user service for the user of an imaging processing execution, and includes a copy application 62, a FAX application 64, a scan application 66, a print application 68, and a Web application 70.

The platform layer 92 provides common services to the application layer 60 through the API 72. For example, ECS (Engine Control Service) 74 provides engine control service for controlling the engine module 46 according to the API 72 instructions (for example, determined function call of programming) from the each application. A MCS 76 provides memory control service, a OCS provides operation panel control service, a FCS 80 provides FAX control service, a NCS 82 provides network control service, a CCS 84 provides certification control service, a Log Management Module 86 provides log management service, and SCS 88 provides system control service. A SRM (System Resource Manager) 90 includes the SCS 88, and provides harmonization of hardware resource acquisition requests from the each control service. In addition, the platform layer 92 includes an OS 94.

The MFP 10 is able to be adaptively configured to include a combination of the applications and common services because of the relation among the application layer 60, the API 72, and the platform layer 92. Thus, the applications and the common services may be added or deleted according to a user's demand.

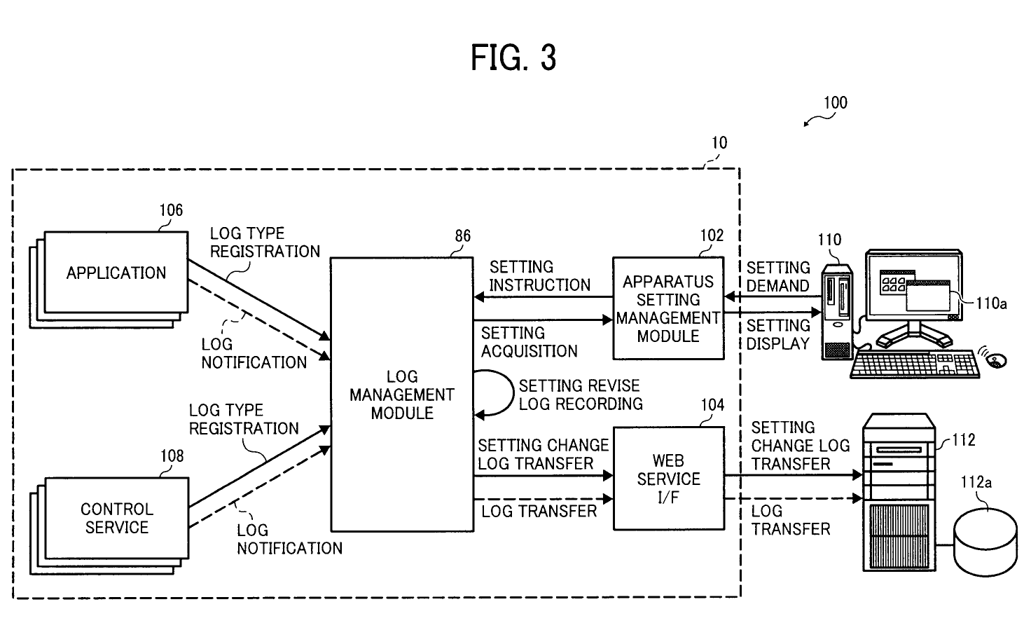

FIG. 3 is a diagram showing a function block configuration of an exemplary log recording system of an image processing apparatus according to an embodiment of the present invention.

Referring to FIG. 3, the log recording system 100 includes the MFP 10, a PC 110 including a Web browser 110a that may be used to alter settings of the MFP 10, and an apparatus management server 112 including storage device 112a for storing collected log information. The MFP 10 is connected to the PC 110 and the apparatus management server 112 through a network. For the log management processing, the MFP 10 includes the log management module 86, the application 106, a control service 108, an apparatus setting management module 102, and a Web Service I/F 104. The application 106 may be any one, or a plurality of, the applications 62-70, and the control service 108 may be any one, or a plurality of, the control services 74-88 (except log management module 86).

The application 106 and the control service 108 may be hardware or software resources used to control process execution, which may be recorded as object log information in the MFP 10.

The application 106 and the control service 108 register a log type at the log management module 86 during a start up (power on) sequence. The log type is a process that may be executed by each of the applications 106 and the control services 108.

The log type is, for example, each type of image processing job executed by the applications 62-70 of the MFP 10, or an access processing (login processing, or logout processing) to the MFP 10 managed by the CCS 84. The log type is registered, from the print application 68, regarding the print job such as “print” or “secrets print,” and from the CCS 84, regarding the access processing such as “login” or “logout.”

The application 106 and the control service 108 notify the log management module 86 of the start, completion, processing information and error information of each process registered to the log type. The log management module 86 records this information as the process log information.

The apparatus setting management module 102 is one of the applications used to confirm apparatus setting and status information through the network. The apparatus setting management module 102 receives a setting instruction from the client PC 110, changes various settings of the MFP 10 based on the received instruction, and sends the setting and status information corresponding to the MFP 10 to the PC 110.

The Web Service I/F 104 is an interface used to perform a message exchange (for example, SOAP or RSS) between the MFP 10 and the apparatus management server 112.

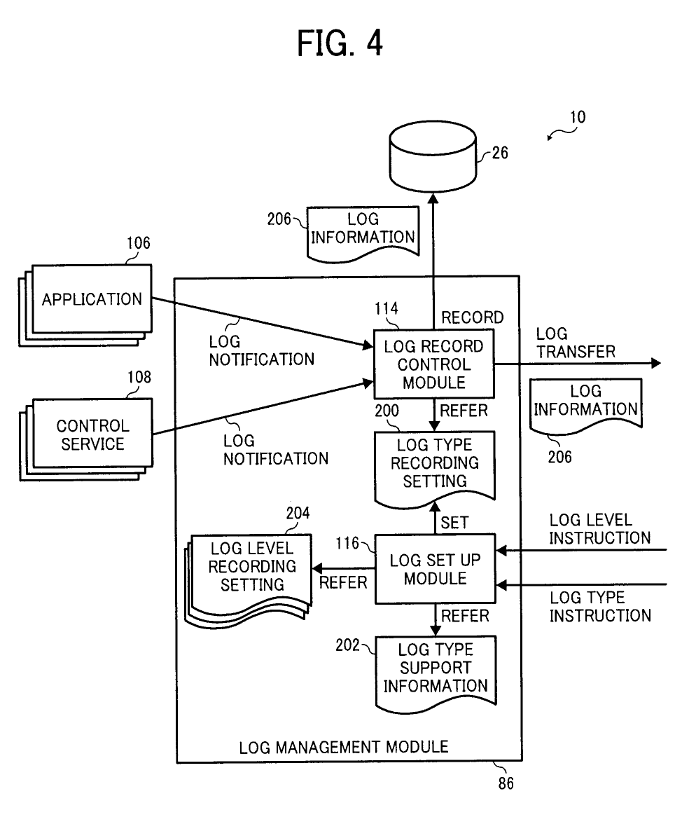

FIG. 4 is a diagram showing a detailed function block diagram of an exemplary log management module of an image processing apparatus according to an embodiment of the present invention.

Referring to FIG. 4, the log management module 86 includes a log record control module 114 that controls log recording, and a log setup module 116 that receives a setup instruction of the log setting from the PC 110 or the operation panel 42 of the MFP 10. The log management module 86 further includes a log type recording setting 200, which describes a relation between the log type and the recording setting.

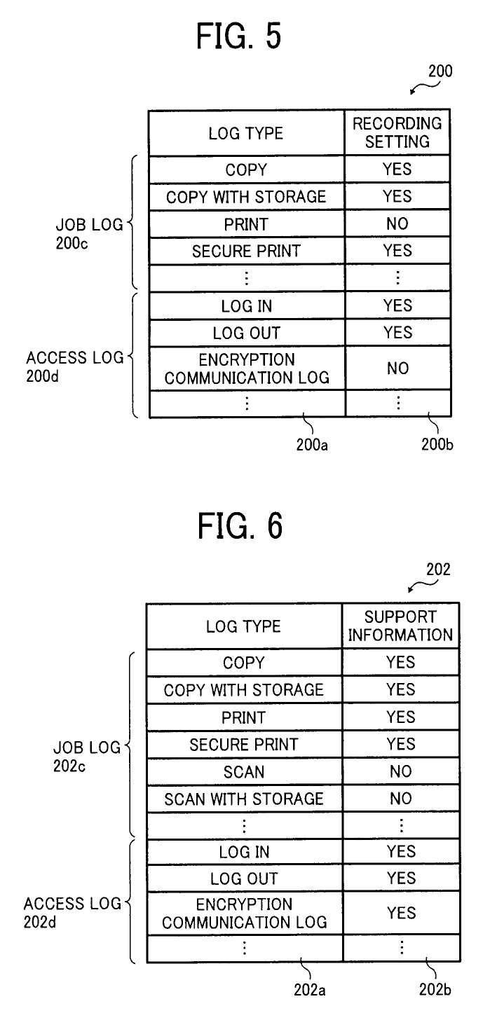

FIG. 5 is a diagram showing a data structure of an exemplary log type recording setting.

Referring to FIG. 5, the log type recording setting 200 includes a log type field 200a, and a recording setting field 200a. The log type is, for example, “copy”, “copy with storage”, “print”, “secure print”, “login”, “logout”, or “encryption communication log.” The recording setting field 200a indicates whether the log type is to be recorded (Yes/No).

Furthermore, each log type may be categorized into categories: a job log 200c, which is recorded as job execution at the MFP 10; and an access log 200d, which relates to access processing at the MFP 10. The user may set the log type recording setting 200 based on these categories.

Referring again to FIG. 4, the log record control module 114 refers the log type recording setting 200 when receiving a notice of start of the processing from the application 106 or the control service 108, determines whether the log information should be recorded, and records the log information to the NV-RAM 26. Further, the log record control module 114 transfers the log information to the apparatus management server 112 through the Web Service I/F 104, which may manage a plurality of MFPs. Also, the log information may be chosen to be routed independently to the apparatus management server 112, and/or the NV-RAM 26.

The log management module 86 forwards a message including various log information to the apparatus management server 112 through the Web Service I/F 104. The log management module 86 further includes log type support information 202, and a log level recording setting 204.

FIG. 6 is a diagram showing a data structure of exemplary log type support information.

Referring to FIG. 6, the log type support information 202 includes a log type field 202a, and a support information field 202b.

As mentioned above, the MFP 10 may include various combinations of applications and common services. Therefore, the log information of the execution may be unique to the MFP 10 based on the applications and common services included in the MFP 10.

In the log type field 202a, a log type exist, which corresponds to the application(s) 106 or the control service(s) 108 installed at the MFP.

The support information field 202b is registered by the application(s) 106 or the control service(s) 108 during a start up sequence.

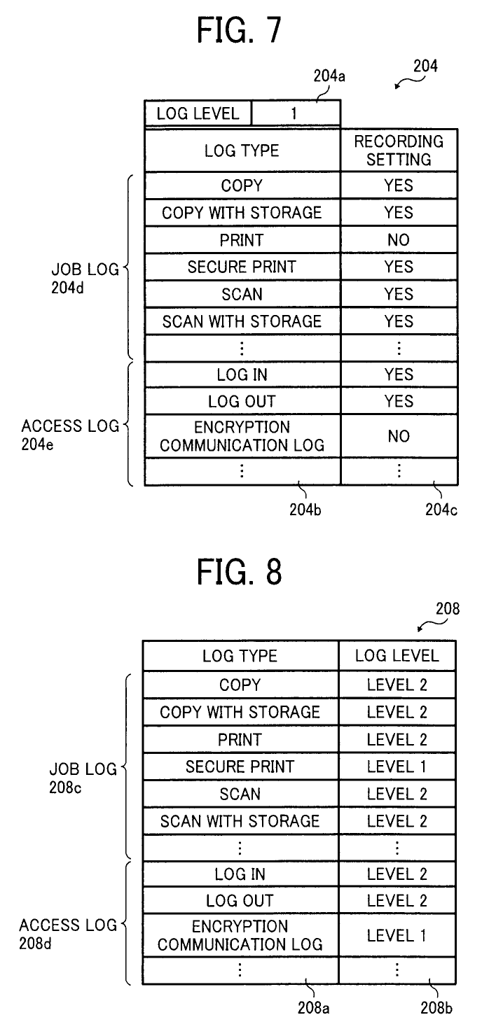

FIG. 7 is a diagram showing a data structure of an exemplary log level recording setting.

Referring to FIG. 7, the log level recording setting 204 includes a log level field 204a, log type field 204b, and a recording setting field 204c. The log level recording setting 204 is prepared for each log level, wherein each log level indicates a recording setting of the log type.

For example, when the user selects the log level, the setting of the record of each log type is set as a predetermined setting in one action. In case the log level is “1”, the log type of “copy”, “copy with storage”, “secure print”, “scan”, “scan to storage”, “login”, and “logout” is recorded, on the other hand, the log type of “print”, and “encryption communication log” is not recorded.

In addition, the log level recording setting 204 may be prepared by a vendor of the MFP 10, or may be set through the operation panel 42 by a system manager of the MFP 10.

The log type recording setting 200, the log type support information 202, and log level recording setting 204 may be stored to the system memory 16, or NV-RAM 26, and may be constructed by any other suitable data format not explicitly described herein (for example, XML data format).

FIG. 8 is a diagram showing a data structure of an exemplary log type-log level recording setting.

Referring to FIG. 8, the log type-log level recording setting 208 includes a log type field 208a, and a log level field 204c.

The log type-log level recording setting 208 is a substitution of the log level recording setting 204 showing in FIG. 7. Whereas the log level recording setting 204 is prepared for every log level beforehand, the log type-log level recording setting 208 is configured to describe relation between the log type and the log level in one table. In this embodiment, the log level may be chosen individually, or may be chosen to be one level that also includes lower levels.

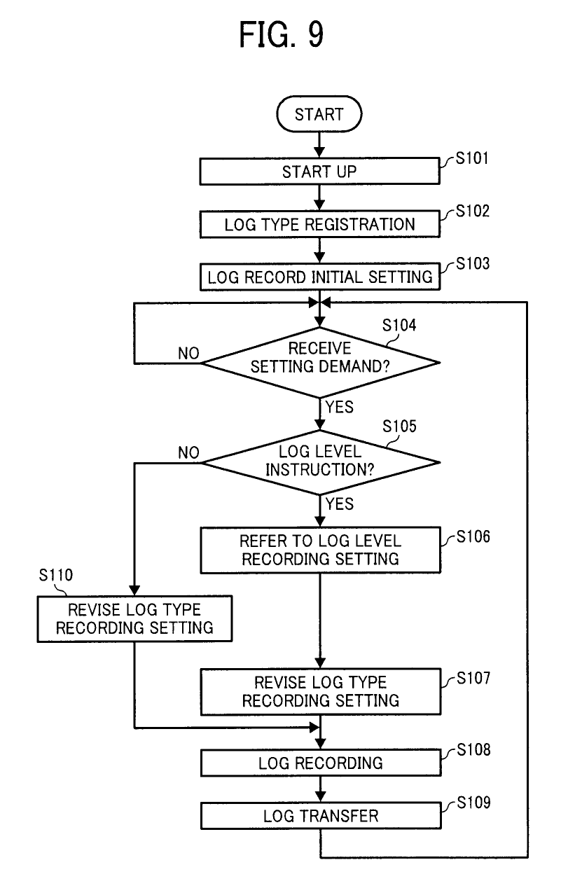

FIG. 9 is a flow chart showing an exemplary process performed at the image processing apparatus according to an embodiment of the present invention.

Referring to FIG. 9, the MFP starts a power on sequence (S101), and a support information field 202b is registered by the application(s) 106 or the control service(s) 108 (S102). The log setup module 116 initializes the log type recording setting 200, referring to the log type support information 202, and the log level recording setting 204 (S103). The log setup module 116 waits for a setting instruction from client PC 110 (S104), and judges whether the setting instruction is log level setting (S105).

In case “Yes” (log level setting) at S105, the log setup module 116 refers to the log level recording setting 204 corresponding to an instructed log level (S106), revises the value of the recording setting of the log type recording setting 200 by referring to each log type registered in the log type support information 202 (S107), records the log information of the setting in the NV-RAM 26 (S108), and forwards the setting to the apparatus management server 112 (S109).

In case “No” (log type setting) at S105, the log setup module 116 revises the log type recording settings 200 (S110). (And follows S108)

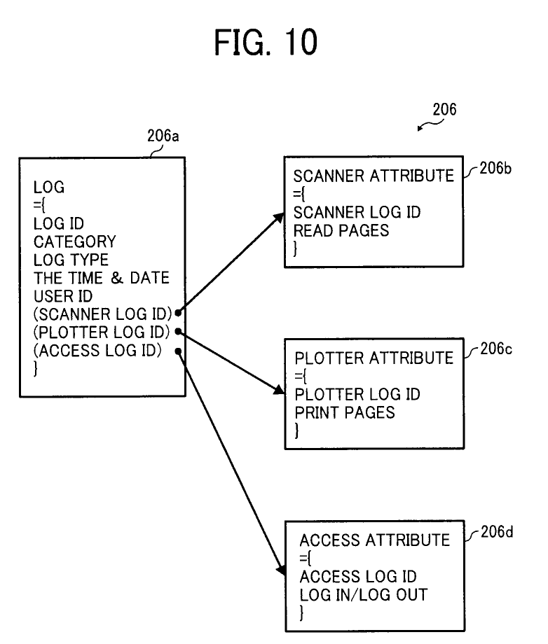

FIG. 10 is a diagram showing a data structure of exemplary log information of the MFP 10.

Referring to FIG. 10, the log information 206 includes a log 206a, a scanner attribute log 206b, a plotter attribute log 206c, and an access attribute log 206d. The log 206a includes a log ID identifying the log information, a category showing the log information “job log”, or “access log”, the log type, the time and date showing processing execution time and date, a user ID showing who execute the processing, a scanner log ID linking the scanner attribute log 206b, a plotter log ID linking the plotter attribute log 206c, and an access log ID linking the access attribute log 206d. The scanner attribute log 206b and the plotter attribute log 206c showing more details of respective engines.

For example, when the log information 206 corresponds to a copy job, the log 206a is set the scanner log ID, the plotter log ID, and the access log ID, and log information is recorded including the scanner attribute log 206b and the plotter attribute log 206c. The scanner attribute log 206b includes information about a document scanning, for example, a number of the read pages of the document. The plotter attribute log 206c includes information about a printing, for example, a number of the printing pages. The access attribute log 206d includes information about an access processing, for example, login or logout information.

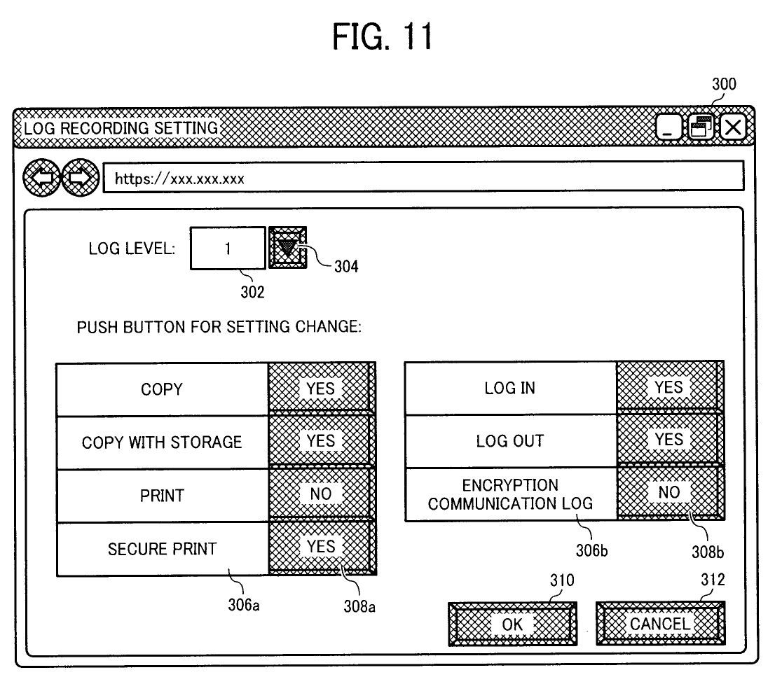

FIG. 11 is a diagram showing a user interface of an exemplary log recording setting.

Referring to FIG. 11, the user interface includes a browser screen 300 of the PC 110. The browser screen 300 includes log level indication 302 indicating a present log level, and a pull-down menu 304 for choosing the log level. This browser screen 300 is prepared corresponding to each of the log level.

The browser screen 300 further includes log type fields 306a, 306b indicating the log type, and recording setting buttons 308a, 308b indicating log recording settings which can be selected to change the recording setting corresponding to each log type. The apparatus setting management module 102 transfers user interface data to the PC 110 to be displayed on the browser screen 300. The browser screen 300 further includes an OK button 310 and a cancel button 312, which allow the selected log settings to be recorded as the log type recording setting 200 or canceled, respectively.

The function mentioned above is realized by software, hardware, or a combination of software and hardware. In the case of software, the software can be distributed by a recording medium, for example, ROM, EEPROM, EPROM, flash memory, flexible disk, CD-ROM, CD-RW, DVD, SD memory, etc.

In the embodiments of the present invention, the image processing apparatus does not need to record all of log information corresponding to the processes executed at the image processing device, but records log information depending on the chosen security level. Therefore, the amount of memory capacity needed to record the log information is reduced, processing load necessary to search the log information from the memory is reduced, and the amount of log information transmitted from the image processing device to an external device is reduced.

What is claimed is:

1. A image processing apparatus, comprising:
a log setting module configured to set a log recording setting corresponding to each of a plurality of processes executed at the image processing apparatus;
a memory configured to store the log recording setting;
a log record control module configured to determine, based on the log recording setting, whether log information should be recorded when at least one of the plurality of processes is executed at the image processing device; and
a memory configured to store log information based on a result of the determination by the log record control module.

2. The image processing apparatus of claim 1, further comprising:
a display configured to display data corresponding to contents of the log recording setting; and
an interface configured to receive an instruction requesting a change in the log recording setting.

3. The image processing apparatus of claim 2, wherein the log setting module is configured to change the stored log recording setting in response to the received instruction.

4. The image processing apparatus of claim 1, wherein the log recording setting includes a log level corresponding to each of the plurality of processes.

5. The image processing apparatus of claim 2, wherein the log recording setting includes a log level corresponding to each of the plurality of processes, and the instruction requesting a change in the log recording setting includes a request to change a log level corresponding to at least one of the plurality of processes.

6. The image processing apparatus of claim 4, wherein the log record control module is configured to determine whether log information should be recorded based on the log level corresponding to each of the plurality of processes.

7. The image processing apparatus of claim 4, further comprising:
an interface configured to receive an instruction requesting that log information be recorded based on a log level corresponding to each of the plurality of processes.

8. The image processing apparatus of claim 1, wherein the log setting module is configured to set a log recording setting corresponding to each of a plurality of processes executed at the image processing apparatus by determining which processes are available at the image processing apparatus during a startup operation.

9. A image processing method, comprising:
setting a log recording setting corresponding to each of a plurality of processes executed at an image processing apparatus;
storing the log recording setting;
determining, based on the log recording setting, whether log information should be recorded when at least one of the plurality of processes is executed at the image processing device; and
storing log information based on a result of the determination by the log record control module.

10. The method of claim 9, further comprising:
displaying data corresponding to contents of the log recording setting; and
receiving an instruction requesting a change in the log recording setting.

11. The method of claim 10, further comprising:
changing the stored log recording setting in response to the received instruction.

12. The method of claim 9, wherein the log recording setting includes a log level corresponding to each of the plurality of processes.

13. The method of claim 10, wherein the log recording setting includes a log level corresponding to each of the plurality of processes, and the instruction requesting a change in the log recording setting includes a request to change a log level corresponding to at least one of the plurality of processes.

14. The method of claim 12, further comprising:
determining whether log information should be recorded based on the log level corresponding to each of the plurality of processes.

15. The method of claim 12, further comprising:
receiving an instruction requesting that log information be recorded based on a log level corresponding to each of the plurality of processes.

16. The method of claim 9, further comprising:
setting a log recording setting corresponding to each of a plurality of processes executed at the image processing apparatus by determining which processes are available at the image processing apparatus during a startup operation.

17. A computer readable storage medium having embodied therein program code for causing a computer to execute an image processing method as claimed in claim 9.

18. A image processing apparatus, comprising:
means for setting a log recording setting corresponding to each of a plurality of processes executed at an image processing apparatus;
means for storing the log recording setting;
means for determining, based on the log recording setting, whether log information should be recorded when at least one of the plurality of processes is executed at the image processing device; and
means for storing log information based on a result of the determination by the log record control module.
